(19) United States
(12) Patent Application Publication
(10) Pub. No.: US 2005/0170122 A1
(43) Pub. Date: Aug. 4, 2005

(54) Multilayer plastic pipe

(76) Inventors: Frank Fahrenholz, Kassel (DE); Werner Zimmer, Melsungen (DE)

Correspondence Address: JENNER & BLOCK, LLP, ONE IBM PLAZA, CHICAGO, IL, 60611, US

(21) Appl. No.: 11/044,668

(22) Filed: Jan. 27, 2005

(30) Foreign Application Priority Data
Jan. 29, 2004 (EP) 04001936.6

(51) Int. Cl. B32B 1/08

(52) U.S. Cl. 428/36.91

(57) ABSTRACT

Multilayer plastic pipe, in particular a multilayer automotive pipeline, is disclosed having the following layers from the outside to inside: a substrate layer of polyamide and/or a blend with a polyamide; a first barrier layer of a barrier layer plastic selected from the group of “ethylene-vinyl alcohol copolymer (EVOH), polyvinylidene fluoride (PVDF), and ethylene-tetrafluoroethylene copolymer (ETFE)” or consisting of a metal foil; at least one separating layer; a second barrier layer consisting of a barrier layer plastic selected from the group consisting of “ethylene-vinyl alcohol copolymer (EVOH), polyvinylidene fluoride (PVDF), and ethylene-tetrafluoroethylene copolymer (ETFE)” or of a metal foil. The separating layer may include an adhesive and/or a polyamide layer or a blend with a polyamide. The barrier layers of a tube may be made of the same material or different materials selected from the identified barrier materials. The innermost layer of the tube may include a conductive substance.

### BACKGROUND OF THE INVENTION

This application claims priority pursuant to Title 35 U.S.C. § 119 to European Patent Application No. 04001936.6 filed Jan. 29, 2004.

This invention relates to a multilayer plastic pipe, in particular a multilayer automotive pipeline. Automotive pipelines are pipelines installed in motor vehicles. They are mainly fuel lines or lines for brake fluid, for example. The term “plastic pipe” also includes a hose and/or a hose line. Within the context of this invention, the term “multilayer plastic pipe” also refers to a pipe containing at least one layer of metal foil in addition to the plastic layers. As a rule, a fluid medium, in particular fuel, is sent through the inventive multilayer plastic pipe.

Multilayer plastic pipes of the type defined above are normally produced by extrusion and/or coextrusion. The layers of the multilayer plastic pipe are designed to be tubular, i.e., cylindrical. Adhesion between the individual layers can be increased by providing adhesion promoter layers in between.

Multilayer plastic pipes of the type described in the preamble are known essentially from practice. These plastic pipes usually have at least one substrate layer of a substrate plastic. Such a substrate layer determines the mechanical strength of the plastic pipe and thus also forms a supporting element for the pipe. The substrate plastic also ensures in particular essential mechanical properties of the pipe such as cold impact strength, elongation, bursting pressure, flexibility and thermal stability of the pipe laminate. The substrate layer or layers of the known plastic pipes are made mainly of polyamide [nylon], e.g., polyamide-12 [nylon-12]. The plastic pipes known from practice also have a barrier layer comprised of a barrier layer plastic. The barrier layer serves as a diffusion barrier for the fluid medium transported in the pipe. For example, the barrier layer should reduce the permeation of hydrocarbons out of the fluid medium transported in the pipe. Barrier layer plastics that may be used include, for example, polyesters such as polyethylene teraphthalate (PET) or polybutylene terephthalate (PBT) or, for example, ethylene-vinyl alcohol copolymers (EVOH) or polyvinylidene fluoride (PVDF) or ethylene-tetrafluoroethylene copolymers (ETFE). In some cases, adhesion promoter layers may be inserted between the individual layers to ensure the cohesion of the laminate. The multilayer plastic pipes known from practice are characterized by the disadvantage that the barrier effect depends greatly on the type of plastic used. Therefore, an optimum barrier effect cannot be achieved with one pipe for all plastics. With such a known plastic pipe, the reduction in permeation can often be ensured successfully only with respect to certain components contained in the media, whereas other components have a higher diffusion, which is not desirable. It may thus happen that a certain multilayer plastic pipe and/or a multilayer fuel line may have satisfactory barrier properties with many fuels but only inadequate barrier properties with other fuels. So far, this has resulted in different fuel systems and/or different fuel lines being manufactured for different countries with different standard national fuel standards. This is of course complex and expensive. Furthermore, there is no guarantee that a vehicle with a certain fuel system will always be operated only in the country of origin. Therefore, the multilayer plastic pipes and/or fuel lines known so far are in need of improvement.

Accordingly, the present invention is based on the technical problem of providing a multilayer plastic pipe and/or multilayer automotive line of the type defined in the preamble, whereby an improvement in barrier properties is also achieved with respect to the use of different fuels or national fuel formulations that are typical of certain countries.

To solve this technical problem, the present invention discloses a multilayer plastic pipe, in particular a multilayer automotive pipeline, and preferably a fuel line, whereby the following layers are provided from the outside to the inside:
a substrate layer of polyamide or a blend containing a polyamide,
a first barrier layer of a barrier plastic from the group consisting of “ethylene-vinyl alcohol copolymer (EVOH), polyvinylidene fluoride (PVDF), etheylene-tetrafluoro-ethylene copolymer (ETFE)” or consisting of a metal foil,
at least one separating layer,
a second barrier layer of a barrier plastic selected from the group consisting of “ethylene-vinyl alcohol copolymer (EVOH), polyvinylidene fluoride (PVDF), ethylene-tetrafluoroethylene copolymer (ETFE)” or consisting of a metal foil.

The inventive multilayer plastic pipe can be produced by extrusion or coextrusion.

The layers of the multilayer plastic pipe are designed to be tubular, i.e., cylindrical. These layers are normally arranged one above the other in a form-fitting and/or bonded arrangement. To improve the bonding of the layers, adhesion promoters may be provided in between.

The substrate layer and/or the substrate plastic determines at least in part the mechanical strength of the multilayer plastic pipe. In particular if the multilayer plastic pipe does not contain any metal foil, the substrate layer, i.e., the substrate plastic of the substrate layer, largely determines the mechanical strength of the pipe. Preferably polyamide-12 [nylon-12], polyamide-6 [nylon-6] and blends thereof are used as the substrate plastics. According to an especially preferred embodiment of this invention, a substrate layer of a substrate plastic forms the outside layer of the plastic pipe.

The term barrier layer in the context of this invention refers to a layer which forms a diffusion barrier for a fluid medium and/or for components of a fluid medium. A barrier layer preferably reduces the permeation of certain components, e.g., hydrocarbons or alcohol components, from the fluid medium transported.

According to a preferred embodiment of this invention, the two barrier layers of the inventive multilayer plastic pipe consists of at least one barrier layer plastic selected from the group consisting of “ethylene-vinyl alcohol copolymer (EVOH), polyvinylidene fluoride (PVDF), ethylene-tetra-fluoroethylene copolymer (ETFE).”

According to another preferred embodiment of this invention, one barrier layer of the plastic pipe consists of a metal foil and the other barrier layer of the plastic pipe consists of at least one barrier layer plastic of the type listed above. According to a particularly preferred embodiment of this invention, the second inside barrier layer is formed by the metal foil. Essentially, however, it is within the scope of this invention for the first outside barrier layer to be formed by the metal foil.

A lightweight metal foil is preferably used as the metal foil, very preferably an aluminum foil. The thickness of the metal foil is expediently 0.03 mm to 0.30 mm, preferably 0.05 mm to 0.20 mm. According to one embodiment, the metal foil may be introduced into the laminate in the form of a metal strip by rolling or bending this metal strip into the shape of a pipe. The overlapping edges of the metal strip are then welded together. It is within the scope of this invention for this welding to be done in the longitudinal direction of the pipe, preferably by an ultrasonic welding method.

According to one embodiment, a separating layer of at least one adhesive is provided between the two barrier layers. It is within the scope of this invention for only one separating layer of an adhesive to be provided between the two barrier layers. The adhesion promoter consists of polyolefin, for example, preferably polyethylene or polypropylene. According to another embodiment of this invention, a separating layer of at least one substrate plastic, in particular polyamide, is provided between the two barrier layers. Expediently, the separating layer consists of polyamide-12 or polyamide-6 or blends thereof. One embodiment of this invention is characterized in that a separating layer of an adhesion promoter and a separating layer of a substrate plastic, preferably a polyamide, are provided between the two barrier layers of the inventive multilayer plastic pipe.

A special embodiment is characterized in that a barrier layer of a first barrier layer plastic with a higher barrier effect with respect to at least one component of a fluid medium is provided, and a barrier layer of a second barrier layer plastic which has a lower barrier effect with respect to said component in comparison with the first barrier layer is also provided. It is within the scope of this invention for the barrier layer consisting of the first barrier layer plastic to have a higher barrier effect with respect to media containing alcohol and for the additional barrier layer for the second barrier layer plastic to have a lower barrier effect with respect to media containing alcohol in comparison with the first barrier layer plastic. The aforementioned barrier effect is thus based on an alcohol component, e.g., methanol and/or ethanol, said alcohol being present in the fuel in particular. The first barrier layer plastic thus presents a greater diffusion barrier with respect to this alcohol component than does the second barrier layer plastic. The first barrier layer plastic preferably consists of an ethylene-tetrafluoroethylene copolymer (ETFE) or a polyvinylidene halide, in particular polyvinylidene fluoride (PVDF). According to one embodiment, the barrier layer of the first barrier layer plastic forms the inside barrier layer of the plastic pipe. The additional barrier layer preferably consists of an ethylene-vinyl alcohol copolymer (EVOH), which in this embodiment comprises the outside barrier layer of the plastic pipe.

It is essentially within the scope of this invention for a barrier layer of the plastic pipe to be made of a barrier layer plastic having a good barrier effect with respect to apolar fluid media and/or having a good barrier effect with respect to an apolar component of the fluid medium. This barrier layer plastic is preferably ethylene-vinyl alcohol copolymer (EVOH).

A particularly preferred embodiment of this invention is characterized in that a barrier layer of a first barrier layer plastic having a higher barrier effect with respect to apolar media is provided, and another barrier layer of a second barrier layer plastic having a lower barrier effect with respect to apolar media in comparison with the first barrier layer plastic is also provided. The term “apolar media” used here refers to a fluid medium, such as a fuel, having at least one apolar component. According to one embodiment of this invention, an outside barrier layer consists of a first barrier layer plastic having a higher barrier effect with respect to apolar media and an inside barrier layer consists of the second barrier layer plastic having a lower barrier effect with respect to apolar media in comparison with the first barrier layer plastic. The first barrier layer plastic having a higher barrier effect with respect to apolar medial is preferably an ethylene-vinyl alcohol copolymer (EVOH). The second barrier layer plastic having a lower barrier effect with respect to apolar media in comparison with the first barrier layer plastic is, however, expediently a polyvinylidene fluoride (PVDF) and/or an ethylene-tetrafluoroethylene copolymer (ETFE).

According to another preferred embodiment of this invention, the one barrier layer as well as the other barrier layer both consist of a barrier layer plastic having a high barrier effect with respect to media containing alcohol, in particular polyvinylidene halide, preferably polyvinylidene fluoride (PVDF) and/or ethylene-tetrafluoroethylene copolymer (ETFE). The phrase “barrier effect with respect to media containing alcohol” refers to a barrier effect with respect to at least one alcohol component present in the fluid medium, in particular in the fuel.

An embodiment of this invention is characterized in that the inside layer of the plastic pipe is a barrier layer consisting of a barrier layer plastic. An inside layer here and as used below refers to the inside layer facing the medium, i.e., the inside layer of the plastic pipe which is directly exposed to the fluid medium being transported in the pipe. If according to this embodiment, the inside layer is a barrier layer, this barrier layer expediently consists of a barrier layer-plastic having a high barrier effect with respect to media that contain alcohol, preferably a polyvinylidene halide, in particular polyvinylidene fluoride (PVDF) and/or an ethylene-tetrafluoroethylene copolymer (ETFE).

However, it is within the scope of this invention for the inside layer to be a barrier layer formed by a metal foil. This embodiment has the advantage that a conductive inside layer is made available through the metal foil.

In a particularly preferred embodiment of the inventive plastic pipe, an outside layer of a polyamide, an outside barrier layer and an inside barrier layer are provided, whereby the outside and inside barrier layers are separated by at least one first separating layer of an adhesion promoter and at least one second separating layer of a polyamide. Preferably only one single first separating layer of an adhesion promoter and a single second separating layer of a polyamide are provided between the two barrier layers.

It is within the scope of this invention for the outside layer and the outside barrier layer of the plastic pipe to be separated by at least one intermediate layer, preferably at least one intermediate layer of an adhesion promoter. Within the scope of this invention, the adhesion promoter may be, for example, a polyolefin, preferably polyethylene or polypropylene.

A preferred embodiment is characterized in that the inside layer consists of plastic, preferably an inventive barrier layer plastic, and is provided with at least one conductive substance. The conductive substance may preferably be conductive carbon black or graphite fibrils. The conductivity of the inside layer effectively prevents an unwanted buildup of electrostatic charge and sudden discharges with the possibility of an explosion.

This invention is based on the finding that a surprisingly high barrier effect with respect to various components in the fluid medium transported can be achieved with an inventive multilayer plastic pipe. It is particularly advantageous within the context of this invention that the pipeline can be used largely independently of the given fluid medium used and/or the fuel used. Essentially, an optimum barrier effect can be achieved with a wide variety of fuels. As a result, an inventive fuel line can be used with the same barrier effect even in different countries where different fuel formulations are used. Consequently, this eliminates the complex production of different fuel systems for different countries. As a result this invention thus yields substantial advantages.

This invention is explained in greater detail below on the basis of exemplary embodiments. The layer sequence of various plastic pipes according to this invention is given from the outside to the inside. The abbreviation PA stands for a polyamide [nylon] or a blend of a polyamide with at least one other polymer. In particular when polyamide forms the outside layer of the plastic pipe, it may be a blend of at least one polyamide with at least one other polymer. The abbreviation HV stands for an adhesion promoter. The abbreviation EVOH stands for ethylene-vinyl alcohol copolymer. The abbreviation ETFE stands for ethylene-tetrafluoroethylene copolymer. The abbreviation PVDF stands for polyvinylidene fluoride, but according to a preferred embodiment, it also denotes a polyvinylidene halide in general. When the name of the plastic of the inside layer is followed by the notation “(If),” this means that this inside layer has been mixed with a conducive substance, e.g., conductive carbon black. In the first four exemplary embodiments, one barrier layer consists of ethylene-vinyl alcohol copolymer (EVOH) which has a high barrier effect with respect to apolar media and a barrier layer either of an ethylene-tetrafluoroethylene copolymer (ETFE) or polyvinylidene fluoride (PVDF), both of which have a high barrier effect with respect to alcohols, in particular with respect to methanol. The latter barrier layer thus manifests a barrier effect, in particular with respect to fuels containing alcohol, i.e., methanol. The layer sequence from the outside to the inside is given as follows:
1. PA/HV/EVOH/HV/PA/ETFE
2. PA/HV/EVOH/HV/PA/ETFE (If)
3. PA/HV/EVOH/HV/PA/PVDF
4. PA/HV/EVOH/HV/PA/PVDF (If)

The next eight exemplary embodiments each include a barrier layer consisting of ethylene-tetrafluoroethylene copolymer (ETFE) and another barrier layer consisting of polyvinylidene fluoride (PVDF). When the adhesion promoter (HV) is shown in parentheses in the following exemplary embodiments, this means that the adhesion promoter is possibly used here as an optional additional layer but is not absolutely necessary.
5. PA/ETFE/PA/(HV/)PVDF
6. PA/ETFE/PA/(HV/)PVDF (If)
7. PA/PVDF/PA/(HV/)ETFE
8. PA/PVDF/PA/(HV/)ETFE (If)
9. PA/HV/ETFE/HV/PA/PVDF (If)
10. PA/HV/ETFE/HV/PA/PVDF
11. PA/HV/PVDF/HV/PA/ETFE (If)
12. PA/HV/PVDF/HV/PA/ETFE

The barrier layer plastic of the first barrier layer and the second barrier layer are identical in the next ten exemplary embodiments:
13. PA/PVDF/PA/(HV/)PVDF
14. PA/PVDF/PA/(HV/)PVDF (If)
15. PA/HV/PVDF/HV/PA/PVDF (If)
16. PA/HV/PVDF/HV/PA/PVDF
17. PA/ETFE/PA/(HV ETFE
18. PA/ETFE/PA/(HV/)ETFE (If)
19. PA/HV ETFE/HV PA ETFE (If)
20. PA/HV/ETFE/HV/PA/ETFE
21. PA/HV/EVOH/HV/EVOH/HV/PA
22. PA/HV/EVOH/HV/EVOH/HV/PA (If)

It is essentially within the scope of this invention for the outside layer which preferably consists of polyamide or a blend of polyamide is additionally sheathed by an outside protective layer which may consist of a thermoplastic elastomer (TPE) and/or a thermoplastic polyurethane (TPU). This additional protective layer ensures a high resistance to high ambient temperatures, e.g., temperatures higher than 130° C. The additional protective layer can be coextruded with the other layers, i.e., plastic layers and thus becomes a component of the laminated structure of the multilayer plastic pipe.

Various features of the present invention have been described with respect to specific embodiments thereof. It must be understood that various changes and modifications may be made by one skilled in the art without departing from the scope of the invention and it is intended and contemplated that the invention encompass such changes and modifications as fall within the scope of the appended claims.

1. A multilayer plastic pipe, in particular a multilayer automotive pipeline, with the following layers being provided from the outside to the inside:
a substrate layer of polyamide or a blend with a polyamide,
a first barrier layer of a barrier layer plastic selected from the group consisting of “ethylene-vinyl alcohol copolymer (EVOH), polyvinylidene fluoride (PVDF), and ethylene-tetrafluoroethylene copolymer (ETFE)” or of a metal foil,
at least one separating layer,
a second barrier layer of a barrier layer plastic selected from the group consisting of “ethylene-vinyl alcohol copolymer (EVOH), polyvinylidene fluoride (PVDF), ethylene-tetrafluoroethylene copolymer (ETFE)” or of a metal foil.

2. The multilayer plastic pipe according to claim 1 wherein the separating layer includes at least one adhesion promoter layer.

3. The multilayer plastic pipe according to claim 1 wherein the separating layer includes at least one substrate plastic layer, in particular a polyamide or a blend with a polyamide.

4. The multilayer plastic pipe according to claim 1 wherein the separating layer includes at least an adhesion promoter layer and at least one layer of substrate plastic, in particular a polyamide or a blend with a polyamide.

5. The multilayer plastic pipe according to claim 1 wherein said first barrier layer and said second barrier layer are of a barrier layer plastic and one of said barrier layers is a barrier layer plastic having a higher barrier effect with respect to the fluid medium transported in the pipe than the barrier layer plastic of the other barrier layer.

6. The multilayer plastic pipe according to claim 5 wherein the barrier material of the second barrier layer has a barrier effect with respect to a flow media containing alcohol, and the first barrier layer has a lower barrier effect with respect to a flow media containing alcohol in comparison with the second barrier layer.

7. The multilayer plastic pipe according to claim 5 wherein the barrier layer of the first barrier layer has a barrier effect with respect to apolar media, and the second barrier layer plastic has a lower barrier effect with respect to apolar media in comparison with the first barrier layer.

8. The multilayer plastic pipe according to claim 1 wherein the two barrier layers consist of a barrier layer plastic having a high barrier effect with respect to media containing alcohol, in particular consisting of polyvinylidene fluoride (PVDF) or ethylene-tetrafluoroethylene copolymer (ETFE).

9. The multilayer plastic pipe according to claim 1 wherein the two barrier layers consist of a barrier layer plastic having a high barrier effect with respect to apolar media, in particular ethylene-vinyl alcohol copolymer (EVOH).

10. The multilayer plastic pipe according to one of claims 1 through 8, wherein the substrate layer and the first barrier layer are separated by at least one intermediate layer of an adhesion promoter.

11. The multilayer plastic pipe according to any of claims 1 to 8 wherein the innermost layer of the pipe consists of a plastic layer, and is provided with a conductive substance.

12. The multilayer plastic pipe according to any of claims 1 to 8 wherein the innermost layer of the pipe consists of a plastic layer, and is provided with a conductive substance formed of carbon fibrils.

13. The multilayer plastic pipe according to any of claims 1 to 4 wherein the inner barrier layer consists of a metal foil.

14. The multilayer plastic pipe according to any of claims 1 to 4 wherein the inner barrier layer consists of a metal foil strip of aluminum having a thickness of from 0.03 mm to 0.30 mm and formed into a tube.

15. The multilayer plastic pipe according to any of claims 1 to 4 wherein said first and second barrier layers are a metal foil.

16. The multilayer plastic pipe according to any of claims 1 to 4 wherein said first and second barrier layers are a metal foil strip of aluminum having a thickness of from 0.03 mm to 0.30 mm and formed into a tube.

17. The multilayer plastic pipe according to any of claim 1 to 8 wherein the substrate layer is sheathed by an outside protective layer selected from the group consisting of a thermoplastic elastomer (TPE) and a thermoplastic polyurethane (TPU).

18. A method of making multilayer plastic pipe, in particular a multilayer automotive pipeline comprising forming said pipe with the following layers from the outside to the inside:
a substrate layer of polyamide or a blend with a polyamide,
a first barrier layer of a barrier layer plastic selected from the group consisting of “ethylene-vinyl alcohol copolymer (EVOH), polyvinylidene fluoride (PVDF), and ethylene-tetrafluoroethylene copolymer (ETFE)” or of a metal foil,
at least one separating layer,
a second barrier layer of a barrier layer plastic selected from the group consisting of “ethylene-vinyl alcohol copolymer (EVOH), polyvinylidene fluoride (PVDF), ethylene-tetrafluoroethylene copolymer (ETFE)” or of a metal foil.

19. A method of making multilayer plastic pipe as claimed in claim 17 wherein said method includes coextrusion of said layers on each other.

20. A method of making multilayer plastic pipe as claimed in claim 18 wherein the separating layer includes at least an adhesion promoter layer and at least one layer of substrate plastic, in particular a polyamide or a blend with a polyamide.

21. A method of making multilayer plastic pipe as claimed in claim 18 wherein said first barrier layer and said second barrier layer are a barrier layer plastic and one of said barrier layers is a barrier layer plastic having a higher barrier effect with respect to the fluid medium transported in the pipe than the barrier layer plastic of the other barrier layer.
